(19) United States
(12) Patent Application Publication
(10) Pub. No.: US 2014/0019375 A1
(43) Pub. Date: Jan. 16, 2014

(54) COMPUTING SYSTEM AND COMPUTER-IMPLEMENTED METHOD FOR FACILITATING THE CHOICE OF AN ACADEMIC OFFERING

(71) Applicant: Richard Harrison Bailey, Inc., Indianapolis, IN (US)

(72) Inventors: Richard H. Bailey, Indianapolis, IN (US); Sam L. Waterson, Indianapolis, IN (US)

(21) Appl. No.: 13/941,184

(22) Filed: Jul. 12, 2013

Related U.S. Application Data
(60) Provisional application No. 61/670,718, filed on Jul. 12, 2012.

(51) Int. Cl. G06Q 50/20; G06Q 10/00

(52) U.S. Cl. CPC G06Q 50/2053; G06Q 10/00
USPC 705/327

(57) ABSTRACT

A computing system and computer-implemented method may be used by prospective students and their influencers to choose an academic offering, such as a college major. The computing system enables its user to query an academic institution's database using exact match terms or intelligent-associated keywords. In response to the query, the computing system may identify an academic offering that most closely matches the search query. In addition, or in the alternative, the computing system may further identify alternative academic offerings. The system and method may further be utilized by academic institutions to tailor academic offerings to prospective students. The collected data may be shared among multiple participating academic institutions, and in some embodiments reports of user data relevant to each academic institution are generated for that institution's consideration and use.

### CROSS REFERENCE TO RELATED APPLICATION

The present application claims the benefit of the provisional patent application having the Ser. No. 61/670,718 (filed on Jul. 12, 2012), the disclosure of which is hereby incorporated by reference in its entirety.

### TECHNICAL FIELD

The present disclosure relates to a computing system and computer-implemented method that may be used by prospective students to choose an academic offering, such as a college major. The system and method may further be utilized by academic institutions to tailor academic offerings to prospective students or attract .students to offerings related to nonacademic subjects in which the prospective student has interest.

### BACKGROUND

Whereas many needs are universal (food, shelter, etc.) much of what we need to flourish is individualized. Choice is what enables each person to pursue those objects and activities that best satisfy one's own preferences within the limits of one's resources. Yet modern life presents us with ever-increasing choices, such as what car to buy, where to take a vacation, or importantly, what college to attend. As the number of choices increases, making an exhaustive investigation of the possibilities becomes more difficult, particularly if dispositive information is not readily available to the individual faced with making a decision.

For example, recent research suggests that the availability of academic offerings ranks among the top three criteria in the minds of prospective students who are faced with the decision of which college to attend. Yet despite this data, most colleges and universities continue to provide academic offering information using course catalogs. Utilizing this format may be problematic in that it may not make the data needed for making an informed decision readily accessible to the prospective student. Inaccessibility may arise for a number of reasons.

First, higher education has a jargon-ridden vernacular that may not be familiar to the layperson. For example, a prospective student may not understand many of the terms utilized in a college course catalog such as “bachelor of science,” “bachelor of arts,” “minor of study,” “externship,” “microbiology,” or “bovine sciences.”

Second, most colleges and universities do not associate careers with searchable academic interests in their course catalogs. Therefore, the link between a desired career and the academic offerings that are listed in a course catalog may not be clear to the prospective student. For example, students who would like to be medical doctors typically look for “pre med” or “biology” as academic offerings that will enable them to pursue a career in medicine. Thus students like these may overlook other viable academic avenues that will enable them to pursue their chosen careers. For example students wishing to be medical doctors may overlook “engineering” and “psychology” as possible majors of study.

Third, colleges and universities have been slow to adapt their course catalogs from their traditional, printed form. Thus the prospective student is left with the often difficult task of searching materials such as PDFs and rudimentary online databases for exact matches of academic offerings; often this results in the prospective student missing alternative academic offerings that may also be of interest to the student.

Given these and other considerations, it is clear that many prospective students may not have access to the data that they need to make the best choice of an academic offering, such as a major of study. Consequently, there is clearly a need for a tool that will facilitate this choice. Moreover, there is a need for a tool that operates effectively in spite of a prospective student's lack of familiarity with the vernacular utilized by academic institutions. Additionally, there is a need for a tool that allows a student to easily explore available options based upon his or her general interests without having to know exactly which academic offerings are relevant to those interests. Further, there is a need for a tool that will allow a student to explore a variety of academic offerings that will lead to his or her career of choice. It would be advantageous if such a tool would allow an academic institution offering the courses of study to gather information about prospective students and their use of the tool so that the tool and the data presented in it may be tailored to facilitate the choices to be made by future students. Moreover, it would be advantageous if such a tool would allow an academic institution to provide academic offerings that more closely match those desired by prospective students.

### SUMMARY

The present disclosure addresses the aforementioned needs by providing a new computing system and computer-implemented method for facilitating a user's choice from a plurality of academic offerings offered by an academic institution. The user may be a prospective student, a current student and/or a student's influencers. Non-limiting examples of influencers include the student's parents, guardians, friends, teachers, high school counselors and college advisors.

In some embodiments, a computing system that facilitates a user's choice of an academic offering from a plurality of academic offerings. The computing system comprises a processor and a memory encoded with programming instructions. The programming instructions are executable to perform a search query, entered by a user, of a database. The database comprises a plurality of academic offerings and intelligent-associated keywords. Each of the intelligent-associated keywords is related to at least one of the plurality of academic offerings, and that relation is stored in the database. In response to the user-entered query, the programming instructions are further executable to process the data in the database and to identify at least a first academic offering from the plurality of academic offerings that most closely matches the user's search query. The programming instructions are further executable to communicate the first academic offering to the user.

In some embodiments, a computing system conveys information to a user regarding an academic offering among a plurality of academic offerings that are proffered by a first academic institution and at least a second academic institution. The computing system comprises a processor and a memory encoded with programming instructions. The programming instructions are executable to perform a user-entered query of a database that contains a plurality of academic offerings offered by the academic institutions and intelligent-associated keywords. Each of the intelligent-associated keywords is related to at least one of the plurality of academic offerings. In response to the user-entered query, the programming instructions are further executable to process data in the database and to identify at least a first academic offering from the plurality academic offerings that most closely matches the user search query. The programming instructions are further executable to communicate the first academic offering to the user. In these embodiments, the first academic institution has a first front end associated with a first unique identifier, and the at least a second academic institution has a second front end associated with a second unique identifier. The user may access the database and perform his or her search through either the first or the second front end.

In some embodiments, the disclosure is directed to a computer-implemented method of facilitating a user's choice from a plurality of academic offerings that are proffered by a first academic institution and at least a second academic institution. The method comprises the following steps. At least a first academic offering that most closely matches a user-queried search of a database is identified. The database comprises the plurality of academic offerings and intelligent-associated keywords from a data set other than academic offerings, and at least some of the intelligent-associated keywords are related to at least one of the plurality of the first academic institution's academic offerings. Each of the intelligent-associated keywords is related to at least one of the academic offerings. At least the first academic offering is communicated to the user. In many of these embodiments, the first academic institution has a first front end associated with a first unique identifier, and the at least a second academic institution has a second front end associated with a second unique identifier. The user may access the database and perform his or her search through either the first or the second front end.

For the purpose of clarity, certain terms used in the description above should be understood as having particular meanings. Thus, the phrase “based on” is used as an indication that something is determined at least in part by the thing that it is identified as being “based on.” When something is completely determined by a thing, it will be described as being “based exclusively on” the thing. Further, a “set” should be understood to mean a number, group, or combination of one or more things of similar nature, design, or function, while an “element” should be understood to refer to a discrete and identifiable thing. Thus, an example of an element from a set of missing information could be a departure time, if the user was expected to provide a departure time, but such time had not yet been provided.

### BRIEF DESCRIPTION OF THE DRAWINGS

It is believed that the inventors' technology will be better understood from the following description of certain examples taken in conjunction with the accompanying drawings, in which like reference numerals identify the same elements and in which:

FIG. 1 is a block diagram showing one embodiment of a computing system according to the disclosure.

FIG. 2 is a block diagram showing another embodiment of a computing system according to the disclosure.

The drawings are not intended to be limiting in any way, and it is contemplated that various aspects of the disclosed technology may be implemented in a variety of other ways, including ways not necessarily depicted in the drawings. The accompanying drawings, incorporated in and forming a part of the specification, illustrate several aspects of the inventors' technology, and together with the description serve to explain the principles of that technology; it being understood however, that the protection accorded by this document or any related document should not be limited to the precise arrangements shown.

### DETAILED DESCRIPTION

The following description of certain examples demonstrates how aspects of the technology disclosed herein could be implemented. Such examples should be understood as being illustrative, and should not be used to limit the protection accorded by this document, or by any related document. Other examples, features, aspects, embodiments and advantages of the inventors' technology will become apparent to those skilled in the art from the following description, which is by way of illustration, one of the best modes contemplated for using the technology disclosed herein. As will be realized, the inventors' technology is capable of different and obvious aspects, all without departing from the material disclosed herein as it would be understood by one of ordinary skill in the art. Accordingly, the descriptions herein should be regarded as illustrative in nature and not restrictive.

The elements or features of the various embodiments are described in detail hereinafter. Any reference to a singular characteristic or limitation of the present disclosure shall include the corresponding plural characteristics or limitations, and vice versa, unless otherwise specified or clearly implied to the contrary by the context in which the reference is made.

The system and methods described herein may comprise, consist of, or consist essentially of the elements and features of the disclosure described herein, as well as any additional or optional components, or features described herein, that are otherwise useful in the systems and methods.

All documents (patents, patent applications and other publications) cited in this application are incorporated herein by reference in their entirety to the extent that they are not inconsistent with the disclosure set forth herein.

As used herein, “academic institution” means a high school, college, university, trade school, or any other institution which proffers academic offerings.

As used herein, an “academic offering” is a course of study. Non-limiting examples of academic offerings include: a certificate program, a major of study, a minor of study, an emphasis of study, a certificate; or the like.

As used herein, “alternative academic offering” means an academic offering that is similar or related to another academic offering. For example, alternative academic options to the college major of “biology” might include the majors “microbiology” or “zoology.”

As used herein, “intelligent-associated keyword” is used interchangeably with “tag” to describe words that are relevant to an academic offering including, but not limited to, a college major. For example, if the college major is “biology,” intelligent-associated keywords may include: “microbiology,” “cells,” and “animals.” In some embodiments, the intelligent-associated keywords include terms and phrases from popular culture. For example, if the college major is “advertising,” the intelligent-associated keywords may include reference to television shows such as “Mad Men®.” In some embodiments, the intelligent-associated keywords include careers that require a certain college major. For example, to have a career as a lab technician, the required college major may be “biology,” or “chemistry.”

As used herein, “electronic messaging” includes electronic communication, for example, via email or posting to websites (including but not limited to social media such as Twitter® or Facebook®).

The present disclosure relates to a computing system and a computer-implemented method for facilitating a user's choice of an academic offering. These and other features of the disclosure are discussed below.

### Computing System

Computing systems for facilitating a user's choice of an academic offering from a plurality of academic offerings may comprise a processor and a memory encoded with programming instructions which are executable to perform a number of functions. In some embodiments or implementations of the computing system, the programming instructions are described as a series of steps. However, those skilled in the art will appreciate that alternative embodiments and implementations are within the scope of this teaching.

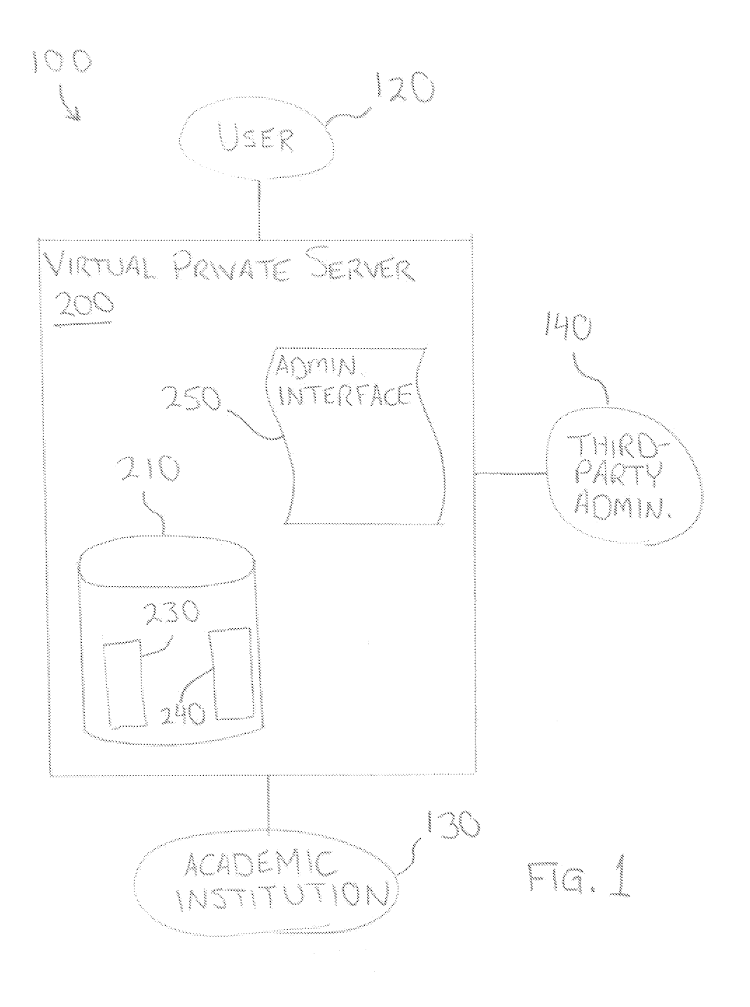

FIG. 1 is a block diagram showing one embodiment of a computing system 100 according to the disclosure. Referencing FIG. 1, a number of participants are each connected to a virtual private server 200, which may be in the form of a web server or other server as would be understood by one of ordinary skill in the art. The participants include a user 120, an academic institution 130 and a third-party administrator 140. Each of the participants has data connections, either permanent or intermittent, to at least the virtual private server 200. In some embodiments, the third-party administrator 140 hosts and/or maintains the virtual private server 200.

The virtual private server 200 stores data in a database 210. A non-limiting example of a useful database is a “MySQL” database. The database 210 comprises a first data set 230 and at least a second data set 240. In some embodiments, the database may further comprise a third data set, a fourth data set, a fifth data set, and so on up to and including as many data sets as are desired. In the embodiment shown in FIG. 1, a first data set 230 contains a listing of the academic offerings that are offered by the academic institution 130. A second data set 240 contains a listing of intelligent-associated keywords, each of which relates to at least one of the academic offerings contained within the first data set 230.

The administrative interface of virtual private server 200 also comprises an administration interface 250. The academic institution 130 may use the administration interface 250 to edit the data in the database 210. For example, the academic institution 130 may add or remove academic offerings from the first data set 230. In a further example, the academic institution 130 may update the intelligent-associated keywords in the second data set 240 to reflect changes in popular culture (e.g., new slang, new television programs and the like) or add a new data set (not shown) to show the same. In a yet further example, the software running on virtual private server 200 is programmed to enable academic institution 130 to add additional data sets.

The user 120 can communicate with the virtual private server 200 through a computing resource (e.g., a computer, a smartphone, a tablet). The user 120 performs a search query of the database 210. Non-limiting examples of search queries include entering an exact match term for an academic offering, and entering an intelligent-associated keyword from the second (or a subsequent) data set.

The computing system 100 is programmed to respond to the user search query by processing the data in the first data set 230 and the second data set 240 to identify at least a first academic offering that most closely matches the user search query. In some embodiments, more than one academic offering that closely matches the user query may be identified. In some embodiments, at least one alternative academic offering in addition to, or in lieu of, the first academic offering is identified.

Once at least a first academic offering is identified, the computing system 100 comprises programming instructions which are executable by the system's processor to communicate the academic offering to the user 120. In some embodiments, the computing system 100 is further programmed with a facility enabling user 120 to share the results of his or her query with others via electronic messaging. Non-limiting examples of electronic messaging include messaging via email, Twitter®, Facebook®, and the like.

The computing system 100 may additionally comprise programming instructions that are further executable by the computer system's processor to collect data about the user 120 and/or his or her use of system 100 (collectively, “user data”) and store it for access via the administrative interface 250 of the virtual private server 200. Any user data that is of use to the academic institution 130 may be collected. In some embodiments, the user data may be selected from the group of: frequency of the user's searching returning a particular academic offering; frequency of the user's search using an intelligent-associated keyword; number of queries made by the user during a search session; amount of time spent by the user making queries during a search session; and number of requests made to share an academic offering via electronic messaging.

The computing system 100 may additionally comprise programming instructions that are further executable by the processor to analyze user data collected in relation to a plurality of users; identify trends in and/or compile aggregate information characterizing the user data collected from the plurality of users; and to report the trends to the academic institution 130. In some embodiments, the processor may automatically execute these steps, and in some embodiments, the steps may be initiated by the third-party administrator 140. In the latter embodiments, the third-party administrator 140 may have access to the computing system of one or more additional academic institutions. In these embodiments, the third-party administrator 130 may be able to synthesize the trends across two or more academic institutions and provide analysis of the synthesized trends to one or more of the academic institutions. In some embodiments, such analysis is automatically performed by software on the virtual private server. The analysis may provide the academic institution(s) with valuable information as to how the users search for academic offerings, their changing interests, goals that resonate with them, and the like, both as to individual users and the users in the aggregate.

The academic institution 130 may modify the database by adding or deleting a data set or by modifying an existing data set. In some embodiments, the modification may be made by the academic institution in response to the reported user trends in order to facilitate future user search queries. In some embodiments, the modification may include the addition of new academic offerings.

In some embodiments the computing system 100 may allow the user 120 to perform a query in an alternative way from the one previously described. Instead of entering the exact match term for an academic offering or an intelligent-associated keyword, the user may perform a query by choosing (for example by clicking with a mouse) an academic offering from a list of academic offerings. In these embodiments, when the academic offering is chosen, an abstract of the academic offering may appear in a window. The window may further contain photos associated with the academic offering and/or similar academic offerings that may be of interest to the user.

In some of these embodiments, the display of the chosen academic offering includes related topics from academia as well as other informational domains. These may be derived from second data set 240 (and/or additional data sets in database 210) of from another source. In some such displays, these related concepts are presented as clickable links to other academic offerings related to the same concept. Some systems are programmed to keep track of the various search queries and selections made by a particular user, then to prioritize and/or filter search results based on relevance to previous queries, mutual relatedness with previous search terms, relationship to other academic offerings that have been viewed, user data, and the like as will occur to those skilled in the art.

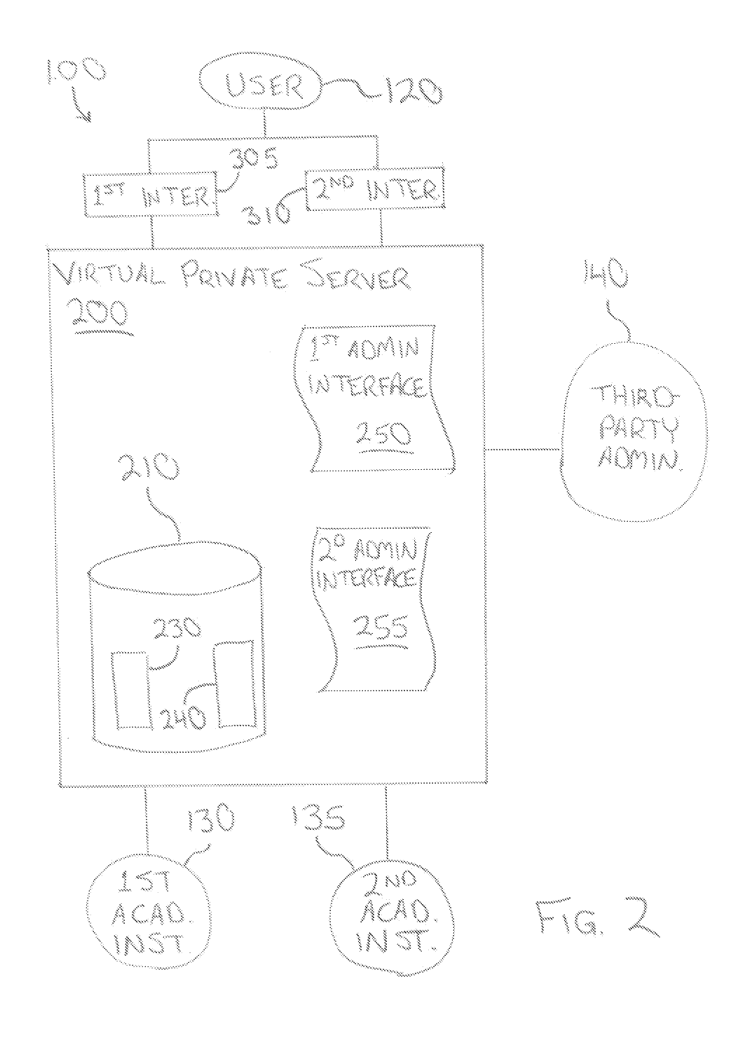

FIG. 2 illustrates various participants in another embodiment of the computing system 100. Unlike the embodiment shown in FIG. 1, the participants in FIG. 2 include more than one academic institution: a first academic institution 130 and a second academic institution 135. In this embodiment, the first academic institution 130 has a branded front end 305 that is coded with a unique identifier, and the second academic institution 135 has a branded front end 310 that is coded with its own unique identifier. Various technologies will occur to those skilled in the art for this coding, including, but not limited to hidden or non-hidden fields transmitted with search queries, browser or Flash® cookies, any of a number of scripting techniques, or the like. In some embodiments, front end 305 is custom-designed responsively to the preferences of first academic institution 130, while in others front end 305 shares a design with second academic institution 135.

In this embodiment, the user 120 accesses the virtual private server 200 through either the branded front end 305 of the first academic institution 130 or the branded front end 310 of the second academic institution 135. The database 210 stores data in a first data set 230 and at least a second data set 240 for both the first academic institution 130 and the second academic institution 135. The first data set 230 contains a listing of the academic offerings that are provided by the first academic institution 130 and/or the second academic institution 135. The second data set contains a listing of intelligent-associated keywords, each of which is related to at least one of the academic offerings contained within the first data set 230.

Additionally, the server 200 contains an administrative interface 250 for the first academic institution 130 and an administrative interface 255 for the second academic institution 135. Each academic institution may use its respective administrative interface to edit the data pertaining to that institution in the database 210. In alternative embodiments, separate tables in database 210 store the information for each respective academic institution and are joined with tables containing the intelligent-associated keyword data sets to produce results for that given academic institution (e.g., responses to queries from that institution's customized front end).

As in the embodiment described with reference to FIG. 1, the user 120 can communicate with the virtual private server 200 through a computing resource (e.g., a computer, a smartphone, a tablet). Unlike the embodiment illustrated in FIG. 1, however, the user might access the virtual private server 200 through either the branded front end 305 of the first academic institution or the branded front end 310 of the second academic institution 135. In some such embodiments, each respective front end is integrated with the organizational website of that particular academic institution.

The user 120 may perform a search of the database 210 as described in connection with the embodiment illustrated in FIG. 1. In response to the user search query, the computing system 100 is programmed to process the data in the first data set 230 and the second data set 240 to identify at least a first academic offering that most closely matches the user search query. In some embodiments, more than one academic offering matching the user query may be identified. In some embodiments, at least one alternative academic offering may be identified in addition to, or in lieu of, the first academic offering.

Once at least a first academic offering is identified, the computing system 100 comprises programming instructions which are further executable by the system's processor to communicate the academic offering to the user 120. The computing system 100 may be further programmed so that the user may share the results of his or her query with other people via electronic messaging. Non-limiting examples of electronic messaging include via email, Twitter®, Facebook® and the like. In addition, or in the alternative, the computing system 100 may be further programmed so that the user may contact the academic institution offering the first academic offering, and/or visit valuable links, such as the academic institution's Facebook® page.

The computing system 100 may additionally comprise programming instructions which are further executable by the computer system's processor to collect data about the user 120 and/or his or her use of computing system 100 (collectively “user data”) and present it in the administrative interface 250 for the first academic institution 130 and the administrative interface 255 for the second academic institution 135. Any user data that is of use to the academic institutions may be collected. In the present embodiment, the user data may be selected from the group of: which academic institution's front end was the conduit for a particular search; frequency of the user's searching returning a particular academic offering; frequency of the user's search using an intelligent-associated keyword; number of queries made by the user during a search session; amount of time spent by the user making queries during a search session; and number of requests made to share an academic offering via electronic messaging.

The computing system 100 may additionally comprise programming instructions that are further executable by the processor to: analyze user data collected in relation to a plurality of users; identify trends in the user data collected from the plurality of users; and to report the trends to the first academic institution 130 and/or the second academic institution 135. In some embodiments, the processor may automatically execute these steps, and in some embodiments, the steps may be initiated by the third-party administrator 140.

Based upon the trends, the first academic institution 130 and/or the second academic institution 135 may wish to modify their course offerings or the characterizations of their course offerings in the database 210. Toward this end, the programming instructions are further executable by the processor so that either academic institution may modify the database 210 by adding or deleting a data set or by modifying an existing data set to more closely match academic offerings with past or future user search queries. In some embodiments, the modification may include the addition of new academic offerings. The programming instructions are further executable by the processor so that the modifications made by each academic institution may be stored in the database 210. The programming instructions may be further executable to collate the modifications, to analyze the modifications and/or to report the modifications to each academic institution and/or to a third-party administrator 140 of the virtual private server 200.

In some embodiments of the computing system described herein, the computing resources that are applied generally take the form of a mobile, laptop, desktop, or server-type computer. The computer, as this example will generically be referred to, includes a processor in communication with a memory, output interface, input interface, and network interface. Power, ground, clock, and other signals and circuitry are used as appropriate as will be understood and easily implemented by those skilled in the art.

The network interface connects the computer to a data network for communication of data between the computer and other devices attached to the network. Input interface(s) manage communication between the processor and one or more touch screens, sensors, push-buttons, UARTs, IR and/or RF receivers or transceivers, decoders, or other devices, as well as traditional keyboard and mouse devices. Output interface(s) provide a video signal to a display, and may provide signals to one or more additional output devices such as LEDs, LCDs, or audio output devices, local multimedia devices, local notification devices, or a combination of these and other output devices and techniques as will occur to those skilled in the art.

The processor in some embodiments is a microcontroller or general purpose microprocessor that reads its program from the memory. The processor may be comprised of one or more components configured as a single unit. Alternatively, when of a multi-component form, the processor may have one or more components located remotely relative to the others. One or more components of the processor may be of the electronic variety including digital circuitry, analog circuitry, or both. In some embodiments, the processor is of a conventional, integrated circuit microprocessor arrangement, such as one or more CORE i3, i5, or i7 processors from INTEL Corporation of 2200 Mission College Boulevard, Santa Clara, Calif. 95052, USA, or OPTERON or PHENOM processors from Advanced Micro Devices, One AMD Place, Sunnyvale, Calif. 94088, USA. In alternative embodiments, one or more reduced instruction set computer (RISC) processors, application-specific integrated circuits (ASICs), general-purpose microprocessors, programmable logic arrays, or other devices may be used alone or in combination as will occur to those skilled in the art.

Likewise, the memory in various embodiments includes one or more types such as solid-state electronic memory, magnetic memory, or optical memory, just to name a few. By way of non-limiting example, the memory can include solid-state electronic Random Access Memory (RAM), Sequentially Accessible Memory (SAM) (such as the First-In, First-Out (FIFO) variety or the Last-In First-Out (LIFO) variety), Programmable Read-Only Memory (PROM), Electrically Programmable Read-Only Memory (EPROM), or Electrically Erasable Programmable Read-Only Memory (EEPROM); an optical disc memory (such as a recordable, rewritable, or read-only DVD or CD-ROM); a magnetically encoded hard drive, floppy disk, tape, or cartridge medium; or a plurality and/or combination of these memory types. Also, the memory in various embodiments is volatile, nonvolatile, or a hybrid combination of volatile and nonvolatile varieties.

Computer programs implementing the methods described herein will commonly be distributed either on a physical distribution medium such as CD-ROM, or via a network distribution medium such as an internet protocol or token ring network, using other media, or through some combination of such distribution media. From there, they will often be copied to a hard disk, non-volatile memory, or a similar intermediate storage medium. When the programs are to be run, they are loaded either from their distribution medium or their intermediate storage medium into the execution memory of the computer, configuring the computer to act in accordance with the method described herein. All of these operations are well known to those skilled in the art of computer systems.

The term “computer-readable medium” encompasses distribution media, intermediate storage media, execution memory of a computer, and any other medium or device capable of storing for later reading by a computer a computer program implementing a method.

### Programming

The computing systems according to an embodiment of the present disclosure comprise a processor and a memory encoded with programming instructions which are executable by the processor to perform a number of functions as described herein. An exemplary work sequence for building the computing systems comprises the following steps, which may be executed in any order that is of use to one skilled in the art.

In one step, the course catalog of an academic institution is obtained and converted into an XML document. The XML document also characterizes a collection of associations between data from different categories, or “data sets.” The collections of associations have contents directed to one or more of the following.

A first category comprises interest tags. Exemplary interest tags may include popular topics which relate to individual academic offerings. For example, “bugs” may be an entry for the major “entomology” or the title of the television show “Crime Scene Investigation®” may be an entry for the major “criminal justice.” Zero, one or multiple interest tags may be associated with each individual major of study.

An additional set of associations may relate to career tags. Exemplary career tags in a data set include popular interests and phrases that relate to individual majors of study. For example, “stock trader” may be a career tag for the major “business,” and “social worker” may be a career tag for the major “sociology.” Zero, one or multiple career tags may be associated with each individual major of study.

Additional data sets and associations may individually have contents selected from the group of: a Uniform Resource Locator (URL); a particular department within the academic institution (e.g., each relevant college within a university); the department in which each major of study is housed; the name of each major of study available within the academic institution; the degrees offered by the academic institution (e.g., a Bachelor of Science, a Bachelor of Arts, a certificate, etc.); a description of each major of study offered by the academic institution, for example, as set forth in the catalog; off-campus study locations associated or available with a particular major of study; a photo folder; a “you may also like” column containing majors of study that are related to the major queried (for example, for the major “Advertising,” “Mass Media” will appear in this column); “naughty words” (i.e., a list of words that will return a response that suggests the term is not valid); an identification (ID) code associated with the academic institution so that its data can be differentiated from that of other universities; and combinations thereof.

In another step in this exemplary method, a MySQL database is constructed using the contents of a series of associations of data in different categories, i.e., data sets, selected from those described above.

In another step, the MySQL database is installed and hosted on a virtual private server.

In another step, the branded administration interface for the academic institution is built. The academic institution may use the administration interface to edit the portion of the data in the database that relates to it.

In another step in this exemplary method, a branded front end for the academic institution is built with a mixture of HTML, CSS, and jQuery. Other languages and/or libraries will be used in other implementations as will occur to those skilled in the art.

In another step, the server side of the system is implemented in PHP to retrieve and display appropriate queried results. Again, other languages and/or libraries will be used in other implementations as will occur to those skilled in the art.

In another step, a JavaScript “on click event” is created for each link on the front end of the database to feed data to a web analytics engine, such as Google Analytics.

### Example

Student R is a junior in high school and has begun her college search. She is interested in F College but is only considering colleges that offer programs that will allow her to achieve her dream of being a patent attorney. R thinks that college F needs to offer “pre-law” in order for her to consider applying for admission to the college.

R visits the F College academic offering site. When she arrives at the site, she sees a full list of College F's academic offerings and a search field.

R first types “pre-law” into the search bar. As she is typing, the list begins to highlight majors that match what she is typing. After she is done typing, the list of majors only includes those related to pre-law. In certain alternative embodiments, the full list is still displayed, but majors related to her input are visually highlighted in the display. In some embodiments, the list is filtered (or selectively highlighted) as R types, while in others, the filtering (or highlighting) is performed only after R indicates that input is complete, such as by pressing an “Enter” key or clicking a “Search” button in the interface.

R then clicks on “pre-law” in the list of majors. The site returns an abstract of the pre-law program at College F, as well as a list of related majors that includes “Political Science,” but also “Biotechnology.” What R does not know is that there are several ways to pursue a career in patent law. College F, recognizing that an educational background in the sciences can provide for a career in patent law, relates the biotechnology major to the “career” of “attorney” and “lawyer.”

R resets her search and enters the television program title “Law and Order” as her query. Using its database of intelligent-associated keywords the system returns “pre-law,” “political science,” “forensics” and “film” as related majors.

R resets her search and queries “patent.” The query returns “pre-law,” “English,” “biology,” “physics,” “chemistry,” “engineering,” and “biotechnology.” R then clicks on biotechnology, and the abstract for the major appears. She is intrigued, so she clicks on the “email” icon and emails the results to her mother. She then wants her friends to know about the site, so she sends a Tweet® to all of her followers and posts it on her Facebook® wall. Finally, she prints a copy of the query results for herself.

### Variations

In addition to the various embodiments described above, variations of the disclosed systems include a variety of automated matching techniques for user queries and automatic construction of the data sets described herein. In some systems, for example, websites of a particular type or character are crawled, and relevant keywords are collected. The associations between such key words and academic offerings are manually or automatically produced based on the relationship between the concepts (or between categories or concepts to which each of them relates). In some alternatives, matching is only done literally, while in others text expansion and varying word forms are accounted for. In the matching algorithms either has the data sets or databases are constructed and/or when the query is being processed. Other techniques for indexing and searching the data sets and databases will occur to those skilled in the art in view of this disclosure.

While the computing system has been illustrated and described in detail in the drawings and foregoing description, the same is to be considered as illustrative and not restrictive in character, it being understood that only the preferred embodiments have been shown and described and that all changes and modifications that come within the spirit of the disclosure are desired to be protected.

What is claimed is:

1. A computing system for facilitating a user's choice of an academic offering from a plurality of a first academic institution's academic offerings, the computing system comprising a processor and a memory encoded with programming instructions executable by the processor to:
receive a user-entered search query;
using the user-entered search query, retrieve a list of a nonzero number of academic offerings from a database that associates each of a plurality of entries from a first data set with one or more entries from a second data set, wherein
the first data set contains the plurality of the first academic institution's academic offerings;
the second data set includes intelligent-associated keywords, and
the retrieving comprises searching the second data set for intelligent-associated keywords that most closely match the user-entered search query and obtaining the list of academic offerings associated with the keywords resulting from that search, where the list of academic offerings comprises a first academic offering; and
communicate the first academic offering to the user.

2. The computing system according to claim 1, wherein
the nonzero number of academic offerings retrieved is two or more; and
the programming instructions are further executable to communicate to the user a second academic offering from the nonzero number of academic offerings in addition to the first academic offering.

3. The computing system according to claim 1, wherein the programming instructions are further executable by the processor to store user data of a person who entered the user-entered search query.

4. The computing system according to claim 3, wherein the user data includes data selected from the group consisting of:
frequency of the user's searching resulting in communication of a particular academic offering;
frequency of the user's searching using a particular intelligent-associated keyword;
number of queries made by the user during a search session;
amount of time spent by the user making queries during a search session; and
number of requests made to share an academic offering via electronic messaging.

5. The computing system according to claim 3, wherein the programming instructions are further executable to:
analyze the user data collected from a plurality of users to generate aggregate user data; and
report the aggregate user data to at least the first academic institution.

6. The computing system according to claim 5, wherein the programming instructions are further executable by the processor to allow the first academic institution to automatically modify the data in the second data set based upon the aggregate user data.

7. The computing system according to claim 5, wherein:
the first data set also contains a plurality of academic offerings of a second academic institution; and
the programming instructions are further executable by the processor to report the aggregate user data to at least the second academic institution.

8. A computing system for facilitating a user's choice from a plurality of academic offerings that are offered by a first academic institution and at least a second academic institution, the computing system comprising a processor and a memory encoded with programming instructions executable by the processor to:
perform a user-entered search query of a database comprising a first data set and a second data set, wherein the first data set contains the plurality of academic offerings and the second data set contains intelligent-associated keywords each of which is related to at least one of the plurality of the first academic institution's academic offerings;
process, in response to the user-entered search query, the data from the first data set and the second data set to identify at least a first academic offering from the plurality of academic offerings wherein the first academic offering most closely matches the user-entered search query; and
communicate the first academic offering to the user;
wherein:
the first academic institution has a first front end associated with a first unique identifier; and
the at least a second academic institution has a second front end associated with a second unique identifier;
and further wherein each of the first front end and the second front end provides the user with access to the database, and the user search query of the database is performed through either the first front end or the second front end such that the search query is associated with either the first unique identifier or the second unique identifier.

9. The computing system according to claim 8, wherein the programming instructions are further executable to communicate to the user at least one alternative academic offering from the plurality of academic offerings in addition to the first academic offering.

10. The computing system according to claim 8, wherein the programming instructions are further executable by the processor to store user data of a person who entered the user-entered search query.

11. The computing system according to claim 10, wherein the user data includes data selected from the group consisting of:
frequency of the user's searching resulting in communication of a particular academic offering;
frequency of the user's searching using a particular intelligent-associated keyword;
number of queries made by the user during a search session;
amount of time spent by the user making queries during a search session; and
number of requests made to share an academic offering via electronic messaging.

12. The computing system according to claim 10, wherein the programming instructions are further executable to:
analyze the user data collected from a plurality of users to generate aggregate user data; and
report the aggregate user data to at least the first academic institution.

13. The computing system according to claim 12, wherein the programming instructions are further executable by the processor to allow the first academic institution to automatically modify the data in the second data set based upon the aggregate user data.

14. The computing system according to claim 13, wherein:
the first data set also contains a plurality of academic offerings of a second academic institution; and
the programming instructions are further executable by the processor to report the aggregate user data to at least the second academic institution.

15. A computer-implemented method of facilitating a user's choice from a plurality of academic offerings, the method comprising the steps of:
responsively to a first user-entered query by a first user, identifying at least a first academic offering by a first academic institution that most closely matches the first user-entered query from a database comprising a first data set and a second data set, wherein the first data set contains a plurality of academic offerings and the second data set contains a plurality of intelligent-associated keywords, each of which is related to at least one of the plurality of academic offerings;
communicating the first academic offering to the first user; and
communicating user data about the first user to a second academic institution;
wherein:
the first academic institution has a first front end associated with a first unique identifier;
the first user-entered query is received through the first front end;
the second academic institution has a second front end associated with a second unique identifier;
the plurality of academic offerings in the first data set includes academic offerings from both the first academic institution and the second academic institution; and
the first user-entered query is accepted from the first user through the first front end and is associated with the first unique identifier.

16. The computer-implemented method of claim 15, wherein the user data includes data selected from the group consisting of:
frequency of the user's searching resulting in communication of a particular academic offering;
frequency of the user's searching using a particular intelligent-associated keyword;
number of queries made by the user during a search session;
amount of time spent by the user making queries during a search session; and
number of requests made to share an academic offering via electronic messaging.

17. The computer-implemented method of claim 15, further comprising the steps of:
analyzing user data collected from a plurality of users to determine aggregate user data; and
reporting the aggregate user data to at least the second academic institution.

18. The computer-implemented method of claim 15, wherein the user data communicated to the second academic institution comprises user data about the user only in the aggregate.

19. The computer-implemented method of claim 15, wherein the user data about the user that is communicated to the second academic institution is anonymized before it is communicated.

20. The computer-implemented method of claim 15, further comprising:
responsively to a second user-entered query, identifying at least a second academic offering by the second academic institution that most closely matches the second user-entered query from the database;
communicating the second academic offering to the second user; and
communicating user data about the second user to the first academic institution;
wherein:
the second user-entered query is received through the second front end; and
the second user-entered query is accepted from the second user through the second front end and is associated with the second unique identifier.
